(19) United States
(12) Patent Application Publication
(10) Pub. No.: US 2024/0151283 A1
(43) Pub. Date: May 9, 2024

(54) BRAKING SYSTEM COMPRISING A FRICTION RING AND A BRAKE HAT

(71) Applicants: Xiaobing Yu, Ostfildern (DE); Björn Betz, Trochtelfingen (DE); Kurosh Davari, Brechen (DE)

(72) Inventors: Xiaobing Yu, Ostfildern (DE); Björn Betz, Trochtelfingen (DE); Kurosh Davari, Brechen (DE)

(73) Assignees: ElringKlinger AG, Dettingen (DE); YANTAI WINHERE AUTO-PART MANUFACTURING CO., LTD, SHANDONG (CN)

(21) Appl. No.: 18/415,929

(22) Filed: Jan. 18, 2024

Related U.S. Application Data
(63) Continuation of application No. PCT/EP2022/069617, filed on Jul. 13, 2022.

(30) Foreign Application Priority Data
Jul. 19, 2021 (DE) 10 2021 118 571.8

(51) Int. Cl. F16D 65/12; F16D 65/02

(52) U.S. Cl. CPC F16D 65/123; F16D 2065/1344; F16D 2065/1364; F16D 2065/1376; F16D 2250/0076

(57) ABSTRACT

A braking system for a motor vehicle is proposed, comprising a friction ring and a brake hat, which is configured for fastening the friction ring to a motor vehicle axle, wherein the friction ring and the brake hat are connected to one another by a self-locking and/or self-braced connection.

### CROSS-REFERENCE TO RELATED PATENT APPLICATION

This application is a continuation of international application number PCT/EP2022/069617 filed on Jul. 13, 2022, and claims the benefit of German application number 10 2021 118 571.8 filed on Jul. 19, 2021.

This patent application relates to the subject matter disclosed in and claims the benefit of international application PCT/EP2022/069617 filed on Jul. 13, 2022, and of German application No. 10 2021 118 571.8 filed on Jul. 19, 2021, the teachings and disclosure of which are hereby incorporated in their entirety by reference thereto for all purposes.

### BACKGROUND OF THE INVENTION

The invention relates to a braking system for a motor vehicle comprising a friction ring and a brake hat, wherein the brake hat is configured for fastening the friction ring to a motor vehicle axle.

### SUMMARY OF THE INVENTION

The object addressed by the invention is that of improving a braking system for a motor vehicle.

In accordance with embodiments of the invention, the object is achieved in that the friction ring and the brake hat are connected to one another by a self-locking and/or self-braced connection.

One advantage of this, for example, is that the friction ring and the brake hat are stably connected to one another even under alternating loads, in particular axial loads, and no play occurs between the friction ring and the brake hat even under the alternating loads.

In particular, this increases the operational safety of the braking system.

In preferred embodiments, it is provided that the connection between the friction ring and the brake hat is configured as a connection that braces at least when the connection between the friction ring and the brake hat is axially loaded relative to a braking system axis, i.e., in particular the connection braces at least when an axial load is applied, and preferably when at least one axial load is applied the connection braces even more strongly than without the load.

In particular, this transfers the load to the bracing between the friction ring and the brake hat, so that the connection remains stable and free of play.

In particular, the braking system axis has a geometric axis, relative to which the brake hat and the friction ring are expediently arranged coaxially and/or relative to which friction surfaces of the friction ring, which are formed in particular on axial outer sides of the friction ring, run substantially perpendicularly.

It is particularly advantageous if, at least when the connection between the friction ring and the brake hat is axially loaded relative to the braking system axis, the connection between the friction ring and the brake hat braces increasingly as the load increases.

In some advantageous embodiments, it is provided that the connection between the friction ring and the brake hat is under preload.

Preferably, the friction ring and the brake hat are thus held against one another without play and the preload also counteracts the formation of play between the friction ring and the brake hat when the connection between the friction ring and the brake hat is under load.

No further details have yet been provided regarding elements of the friction ring and the brake hat that form the connection between them.

In advantageous embodiments, it is provided that parts of the friction ring and parts of the brake hat which at least partially form the connection between the friction ring and the brake hat are wedged together.

In particular, the friction ring and the brake hat are connected to one another stably and without play by the wedged parts, and the wedged-together parts counteract the formation of play between the friction ring and the brake hat.

It is particularly advantageous if the wedged-together parts form a wedge connection which preferably acts as a self-clamping system, i.e., jams in itself when a load is applied, in order to counteract the load and ensure a stable connection between the brake hat and the friction ring, wherein preferably the parts of the wedge connection brace together all the more, the greater the load, in particular in the axial direction relative to the braking system axis, so that advantageously no axial gap and thus no play is permitted between the friction ring and the brake hat and in particular axial protection is provided.

For example, the wedging of the parts forming the connection and/or the braced connection is advantageous in order to compensate for tolerances in the parts of the friction ring and the brake hat forming the connection between them.

Further details regarding the parts forming the connection between the friction ring and the brake hat have not yet been provided.

It is particularly expedient if the connection between the friction ring and the brake hat is at least partially formed from a plurality of retaining surfaces and retaining elements that bear against a respective retaining surface.

It is particularly advantageous if at least some of the plurality of retaining surfaces run obliquely to the braking system axis.

In particular, the obliquely running retaining surfaces each form a wedge surface against which the respective retaining element is placed.

In particular, it is advantageous here that a respective retaining element can be applied to the obliquely running retaining surface particularly expediently, for example in a wedging manner, thus forming a self-locking and/or self-braced connection, in particular a wedge connection.

In the case of the obliquely running retaining surfaces, it is particularly expedient that the retaining element bearing against the oblique retaining surface is displaced along the incline when an axial load is applied, so that the adjacent retaining element bears against the respective retaining surface without play even under an axial load that changes, for example.

In particular, the at least some oblique retaining surfaces run at an angle oblique to the axial direction of the braking system axis which is at least 30°, preferably at least 40°, for example at least 50°, and/or is less than or equal to 85°, preferably less than or equal to 80°.

Preferably, at least some of the plurality of retaining elements bear against the respective retaining surface under preload, so that, for example, tolerances at the retaining surface and the retaining element are compensated for in the case of the retaining elements bearing under preload and, advantageously, the preload ensures that the respective retaining element remains placed against the retaining surface without play even when the connection is subjected to an axial load in particular, thus forming a stable connection.

In particular, at least some, preferably all, of the retaining elements bearing against an obliquely running retaining surface bear against this surface under preload.

In expedient embodiments, it is provided that at least some of the plurality of retaining elements, preferably at least most, for example all, of the plurality of retaining elements, are formed by the brake hat.

In particular, at least some of the plurality of retaining surfaces, preferably at least most, for example all, of the plurality of retaining surfaces, are formed on the friction ring, for example a friction disk thereof.

No further details have yet been provided regarding further configurations of the brake hat and the friction ring.

In particular, it is provided that the brake hat comprises a casing wall, which in particular runs substantially cylindrically to the braking system axis.

Preferably, the brake hat has a mounting base, which is configured in particular for mounting the brake hat on a vehicle axle.

In particular, it is provided that the casing wall extends away from the mounting base in the axial direction relative to the braking system axis.

In particular, the casing wall is connected to the mounting base at one axial end of the latter, for example indirectly by means of a transition portion or directly, and has an opposite, free axial end.

In particular, the casing wall runs circumferentially around the braking system axis in a closed manner.

In particular, the friction ring has an axle aperture, which is configured in particular so that a vehicle axle is guided through the axle aperture in the fully assembled state and, in particular, the brake hat engages at least partially into the axle aperture with the casing wall.

The friction ring expediently consists of at least one friction disk, for example of two friction disks.

In particular, the at least one friction disk and/or each of the two friction disks has its own axle opening, wherein the one axle opening or the plurality of axle openings form the axle aperture.

Advantageously, the friction ring and the brake hat are connected to one another torque-transmittingly.

Preferably, the casing wall of the brake hat has a toothing and the friction ring has a tooth system corresponding to the toothing, wherein in particular the toothing and the tooth system are toothed together torque-transmittingly.

In particular, the toothing is formed from the casing wall, in particular from wall segments arranged offset to one another in relation to the radial direction of the braking system axis.

In particular, the toothing of the brake hat has teeth and recesses, wherein a recess is arranged between two teeth in each case.

In particular, one tooth of the toothing of the brake hat extends in a radial direction relative to the braking system axis with a tooth front facing outward, and tooth flanks on both sides of the tooth front run obliquely radially inward to a respective recess back of a respective one of two recesses arranged on both sides of the tooth.

In particular, a respective recess is delimited on both sides by a tooth flank of a respective tooth arranged next to the recess and is delimited in the radial direction by the recess back.

In particular, the tooth fronts and the recess backs are formed by respective wall segments that are radially offset relative to the braking system axis and arranged alternately on the circumferential side, wherein wall segments running obliquely to the radial direction connect a respective tooth front and a recess back to one another as tooth flanks.

The toothing of the friction ring is formed, for example, on a friction disk of the friction ring.

In particular, the tooth system is formed by teeth projecting radially relative to the braking system axle into the axle aperture, in particular into the axle opening of the friction disk forming the tooth system, and by recesses arranged circumferentially between the teeth.

In particular, the teeth project with a tooth front into the axle aperture, in particular into the axle opening, and a respective tooth has two tooth flanks which extend radially outward from the tooth front and in each case laterally delimit one of two recesses arranged on both sides of the tooth and extend as far as a respective recess back of the respective recess. The recess back delimits the corresponding recess in a radial direction relative to the braking system axis.

In particular, at least some, for example at least most, preferably all, of the plurality of retaining elements are formed from the casing wall.

Preferably, it is provided that at least some, for example most, preferably all, of the plurality of retaining elements are each formed in a respective recess between two teeth of the tooth system of the brake hat.

Preferably, at least some, preferably at least most, in particular all, of the plurality of retaining elements each comprise a retaining part which bears against the respective retaining surface.

With at least some of the retaining elements, it is provided that their retaining part is fastened to the casing wall with two fastening parts of the retaining element.

In particular, this achieves a stable fastening of the retaining part that is capable of resisting even under load.

With these retaining elements in particular, the retaining part is arranged in the circumferential direction between the two fastening parts, wherein the fastening parts preferably extend laterally obliquely to the casing wall.

Preferably, it is provided that at least some of the plurality of retaining elements are fastened to a respective tooth flank of the tooth system of the casing wall, i.e., in particular are fastened to at least one tooth flank delimiting the recess in which the retaining element is formed, or preferably are fastened to the two tooth flanks delimiting the recess.

In the case of retaining elements with fastening parts, it is advantageous if the fastening parts are fastened to a respective tooth flank.

It is particularly advantageous if the retaining part extends transversely to the circumferential direction around the braking system axis and/or transversely to the direction in which the fastening parts are arranged on both sides, obliquely to the axial direction of the braking system axis.

It is advantageous if at least some of the plurality of retaining elements bear on their corresponding retaining surface obliquely to the axial direction of the braking system axis.

Preferably, an extension of the retaining part extending away from the retaining surface runs, from the retaining element bearing against this retaining surface, obliquely to the axial direction of the braking system axis.

In particular, a course and/or a direction is oblique to another direction, in this case the axial direction, if an angle between these is at least 5°, preferably at least 10°, and/or is less than or equal to 85°, in particular less than or equal to 80°.

In particular, this enables a wedging connection between the retaining element and the retaining surface in an expedient manner.

Preferably, in the event of an axial load, the retaining element bearing obliquely in relation to the braking system axis absorbs one component of the axial load and is displaced along the retaining surface by the other component of the axial load, which is aligned in particular at least substantially perpendicular to the absorbed component, so that the connection between the friction ring and the brake hat advantageously remains stable and free of play even under an axial load.

Preferably, at least the retaining elements bearing against a retaining surface that runs obliquely to the braking system axis has a retaining part and two fastening parts that connect this retaining part to the casing wall.

It is expedient if the retaining elements bearing against a retaining surface that runs obliquely to the braking system axis rest on the corresponding retaining surface obliquely to the braking system axis.

Advantageously, the retaining elements bearing against the retaining surface running obliquely to the braking system axis bear against the retaining surface, in particular with their respective retaining part, in such a way and this oblique retaining surface is formed in such a way that, in the event of an axial load, the retaining element, in particular its retaining part, absorbs one component of the axial load and the retaining element, in particular its retaining part, is displaced along the preferably oblique retaining surface by the other component of the axial load.

Preferably, the retaining part is held at least partially elastically on the casing wall by means of the fastening parts, so that the retaining part can absorb changing axial loads and at the same time remains free of play in contact with the retaining surface, creating a stable connection.

In particular, the brake hat comprises two groups of retaining elements, wherein the retaining elements of one of the two groups are arranged at one axial height of the casing wall and the retaining elements of the other of the two groups are arranged at another axial height of the casing wall, and the retaining elements of the two groups hold the friction ring between them in an axial direction relative to the braking system axis.

In particular, this ensures that the friction ring is secured axially in an expedient way.

Preferably, the retaining elements of the two groups hold, between them in the axial direction, the edge portion surrounding the axle opening of a friction disk of the friction ring.

It is preferably provided that the retaining elements of one of the two groups are formed at a free axial end of the casing wall.

In particular, the retaining elements of the other of the two groups are arranged here at such an axial distance from the free end of the casing wall that the friction ring can be held between the retaining elements of the two groups.

Preferably, the retaining elements of one of the two groups are configured as axial stops so that, advantageously, the brake hat can be inserted into the axle aperture of the friction ring during assembly of the braking system and can be positioned correctly relative to the friction ring, in particular in the axial direction, by means of the retaining elements formed as stops, since the retaining elements strike as stops against a corresponding retaining surface on the friction ring.

Advantageously, at least some of the plurality of retaining elements, in particular the retaining elements of one of the two groups, and expediently their corresponding retaining surfaces are formed on the friction ring in such a way that the retaining elements are formed by a radial shaping from the casing wall of the brake hat and advantageously can be placed and are placed directly against their corresponding retaining surface by the radial shaping.

In particular, this makes assembly easier, as the radial shaping forms the retaining elements in a single step and places them directly against the retaining surface.

In particular, it is provided that at least one slot is formed on a respective recess back of a recess of the toothing of the brake hat between the part from which the retaining element is formed and the remaining portion of the recess back, so that the shaping of the retaining element is facilitated.

Preferably, the retaining surfaces formed by radial shaping are placed against a retaining surface running obliquely to the braking system axis, so that a self-braced and/or wedged connection is formed in a simple manner.

In some expedient embodiments, it is provided that the radially shaped retaining elements are formed from the casing wall at an axial distance from the free axial end of the casing wall.

In preferred embodiments, it is provided that the radially shaped retaining elements are formed from the casing wall at the free axial end of the casing wall.

In particular, the retaining elements of one of the two groups are formed as axial stops and the retaining elements of the other of the two groups are formed by radial shaping, in particular as explained above in a preferred manner.

Further details regarding the holding surfaces have not yet been provided.

Preferably, at least some, preferably at least most, in particular all, of the plurality of retaining surfaces are formed on the tooth system of the friction ring.

In particular, at least some, especially most, for example all, of the plurality of retaining surfaces are formed on an edge portion surrounding the axle opening of a friction disk of the friction ring.

Preferably, the plurality of retaining surfaces are formed on axial end sides of the edge portion opposite the braking system axis in the axial direction, so that some of the plurality of retaining surfaces are formed on one of the two axial end sides and the other of the plurality of retaining surfaces are formed on the other of the two axial end sides.

In advantageous embodiments, it is provided that at least some of the plurality of retaining surfaces, for example at least most, in particular all, of the plurality of retaining surfaces, are formed on a respective tooth of the tooth system of the friction ring.

It is particularly expedient if at least some, for example most, preferably all, of the plurality of retaining surfaces formed on a respective tooth are formed at an end of the tooth that is axial relative to the braking system axis.

This allows the retaining surface to be formed on the tooth system in a structurally simple manner and a corresponding retaining element to be placed against the respective retaining surface.

Preferably, it is provided here that some of the retaining surfaces are formed at axial ends of their tooth on one of the two axial end sides of the edge portion and the other of the retaining surfaces are formed at an axial end of a tooth on the other of the two axial end sides of the edge portion.

This means that retaining surfaces are arranged at both axial end faces and the retaining elements bearing against these retaining surfaces secure the friction ring axially relative to the brake hat.

It is particularly advantageous if at least some of the plurality of retaining surfaces, in particular most, for example all, of the plurality of retaining surfaces, are formed on the friction ring, in particular on its tooth system and/or on the edge portion of a friction disk, in such a way that a free region on a respective retaining surface opens freely into the axle aperture of the friction ring, in particular into the axle opening of the friction disk, in the radial direction relative to the braking system axis, in particular at least as long as the brake hat, for example with its casing wall, is not yet at least partially inserted into the axle aperture.

Preferably, it is provided that a respective part of the casing wall of the brake hat, in particular a recess back, is arranged directly adjacently to the free region of at least some of the plurality of retaining surfaces, in particular most, for example all, of the plurality of retaining surfaces.

In particular, this makes it possible to shape the respective retaining element to be applied to one of these retaining surfaces in a single step by radial forming from the casing wall, in particular from the subsequently arranged part of the casing wall, and to apply it directly to the corresponding retaining surface.

It is preferably provided here that at least some, in particular most, for example all of the retaining surfaces formed in this way run obliquely to the braking system axis.

In the foregoing and hereinafter, features which are described as being provided preferably, in particular, for example, expediently and/or advantageously and/or the like are optional features which are not essential for the basic invention and represent, for example, advantageous, inventive further developments.

In the foregoing and hereinafter, the term “at least substantially” in conjunction with a feature is to be understood in particular to mean that technically irrelevant and/or technically induced deviations, for example from a specified value, are included by the feature fundamentally specified.

In the foregoing and hereinafter, the wording “at least approximately” is to be understood as meaning that these features are at least substantially provided and/or that deviations of up to +/−20%, for example of +/−10%, in particular of +/−5% from the at least approximately indicated specification, in particular of a value, are included. For example, deviations of up to +/−20°, preferably of up to +/−15°, in particular of +/−10°, in particular of up to +/−5° are included in a direction indicated at least approximately.

The above description of solutions according to the invention thus comprises, in particular, the various combinations of features defined by the following consecutively numbered embodiments:
1. A braking system (100) for a motor vehicle, comprising a friction ring (112) and a brake hat (114) which is configured for fastening the friction ring (112) to a motor vehicle axle, wherein the friction ring (112) and the brake hat (114) are connected to one another by a self-locking and/or self-braced connection.
2. A braking system (100) in accordance with embodiment 1, wherein the connection between the friction ring (112) and the brake hat (114) is configured as a connection between the friction ring (112) and the brake hat (114) which braces at least in the event of an axial load on the connection relative to a braking system axis (118), in particular wherein the connection braces even more strongly at least in the event of an axial load relative to a braking system axis (118).
3. A braking system (100) in accordance with the preceding embodiments, wherein the connection between the friction ring (112) and the brake hat (114) braces increasingly as the load increases, at least when the load is axial relative to the braking system axis (118).
4. A braking system (100) in accordance with the preceding embodiments, wherein the connection between the friction ring (112) and the brake hat (114) is under preload.
5. A braking system (100) in accordance with the preceding embodiments, wherein parts (172, 184) of the friction ring (112) and parts (312, 314) of the brake hat (114), which at least partially form the connection between the friction ring (112) and the brake hat (114), are wedged together.
6. A braking system (100) in accordance with the preceding embodiments, wherein the connection between the friction ring (112) and the brake hat (114) is formed at least partially from a plurality of retaining surfaces (332, 362) and a plurality of retaining elements (312, 314) which bear against a respective retaining surface (332, 362).
7. A braking system (100) in accordance with the preceding embodiments, wherein at least some of the plurality of retaining surfaces (332, 362) extend obliquely to the braking system axis (118).
8. A braking system (100) in accordance with the preceding embodiments, wherein at least some of the plurality of retaining elements (312, 314) bear against the respective retaining surface (332, 362) under preload.
9. A braking system (100) in accordance with the preceding embodiments, wherein at least some of the plurality of retaining elements (312, 314) are formed by the brake hat (114) and at least some of the plurality of retaining surfaces (332, 362) are formed on the friction ring (112).
10. A braking system (100) in accordance with the preceding embodiments, wherein a casing wall (214) of the brake hat (114) has a toothing (232) and the friction ring has a tooth system (182) corresponding to the toothing (232), wherein in particular the toothing (232) and the tooth system (182) are toothed together torque-transmittingly.
11. A braking system (100) in accordance with the preceding embodiments, wherein at least some of the plurality of retaining elements (312, 314) are formed from the casing wall (214).
12. A braking system (100) in accordance with the preceding embodiments, wherein at least some of the plurality of retaining elements (312, 314) are each formed in a respective recess (236) between two teeth (234) of the tooth system (182) of the brake hat (114).
13. A braking system (100) in accordance with the preceding embodiments, wherein at least some of the plurality of retaining elements (312, 314) each comprise a retaining part (352) resting against the respective retaining surface (332, 362), and wherein in particular the retaining part (352) is fastened to the casing wall (214) by means of two fastening parts (354, 356) of the retaining element (312, 314).
14. A braking system (100) in accordance with the preceding embodiments, wherein at least some of the plurality of retaining elements (312, 314) are fastened, in particular by their fastening parts (354, 356), to a respective tooth flank (244) of the tooth system of the casing wall (214).
15. A braking system (100) in accordance with the preceding embodiments, wherein at least some of the plurality of retaining elements (312, 314), in particular with their respective retaining part (352), bear obliquely to the braking system axis (118) on the corresponding retaining surface (332, 362).
16. A braking system (100) in accordance with the preceding embodiments, wherein the brake hat (114) comprises two groups of retaining elements, wherein the retaining elements (312, 314) of one of the two groups are arranged at one axial height of the casing wall (214) and the retaining elements (312, 314) of the other of the two groups are arranged at a different axial height of the casing wall (214), and the retaining elements (312, 314) of the two groups hold the friction ring (112) between them in the axial direction relative to the braking system axis (118).
17. A braking system (100) in accordance with the preceding embodiments, wherein the retaining elements (312, 314) of one of the two groups are formed at a free axial end (324) of the casing wall (214).
18. A braking system (100) in accordance with the preceding embodiments, wherein at least some of the plurality of retaining elements (312, 314) are formed by radial shaping from the casing wall (214) of the brake hat (114) and, in particular, are placed directly against the corresponding retaining surface (332, 362) by the radial shaping.
19. A braking system (100) in accordance with the preceding embodiments, wherein at least some of the plurality of retaining surfaces (332, 362) are formed on the tooth system (182) of the friction ring (112).
20. A braking system (100) in accordance with the preceding embodiments, wherein at least some of the plurality of retaining surfaces (332, 362) are formed on an axial end of a respective tooth (184) of the tooth system (182) of the friction ring (112) relative to the braking system axis (118).
21. A braking system (100) in accordance with the preceding embodiments, wherein at least some of the plurality of retaining surfaces (332, 362) are formed on the friction ring (112) in such a way that a free region on a respective retaining surface (332, 362) opens freely into an axle aperture of the friction ring (112) in the radial direction relative to the braking system axis (118).
22. A braking system (100) in accordance with the preceding embodiments, wherein a respective part of the casing wall (214) of the brake hat (114), in particular a recess back (246), is arranged directly adjacent to a free region of at least some of the plurality of retaining surfaces (332, 362).

Preferred features and advantages of the invention are the subject of the following detailed description and graphical representation of an exemplary embodiment.

### BRIEF DESCRIPTION OF THE DRAWINGS

The drawings show:

FIG. 1 a perspective view of a friction ring and a brake hat, which are connected to one another, of the exemplary embodiment;

FIG. 2 an exploded view of the brake hat and the friction ring;

FIG. 3 a plan view of the brake hat and the friction ring;

FIG. 4 a sectional view of the brake hat and the friction ring according to the section IV-IV shown in FIG. 3;

FIG. 5 a perspective view of a detail of a tooth system of the friction ring;

FIG. 6 an enlarged view of a detail of a toothing of the brake hat;

FIG. 7 an enlarged detailed view of the region labeled VII from the section shown in FIG. 4;

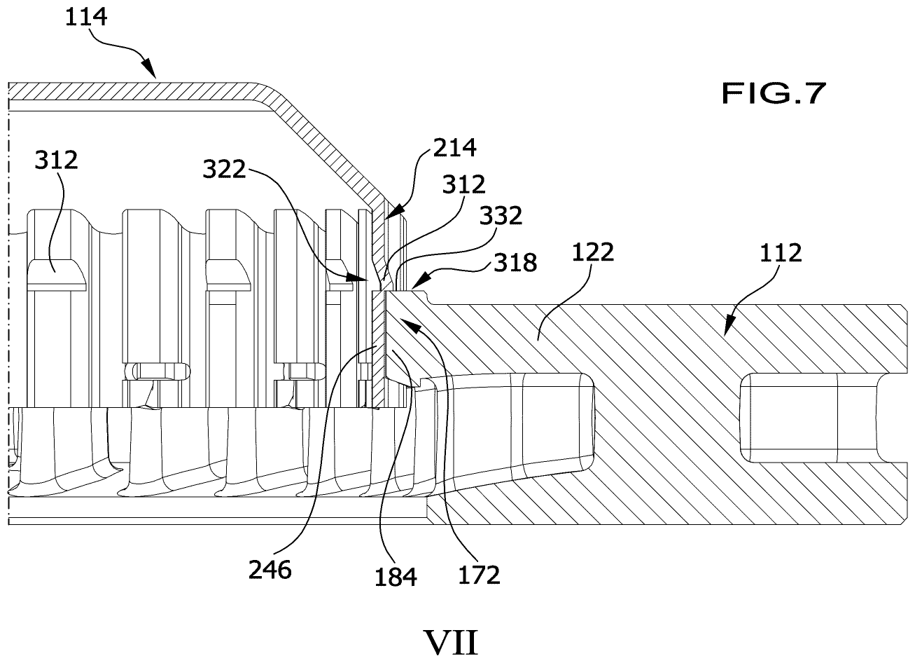

FIG. 8 an enlarged detailed view of the region labeled VIII from the section shown in FIG. 4;

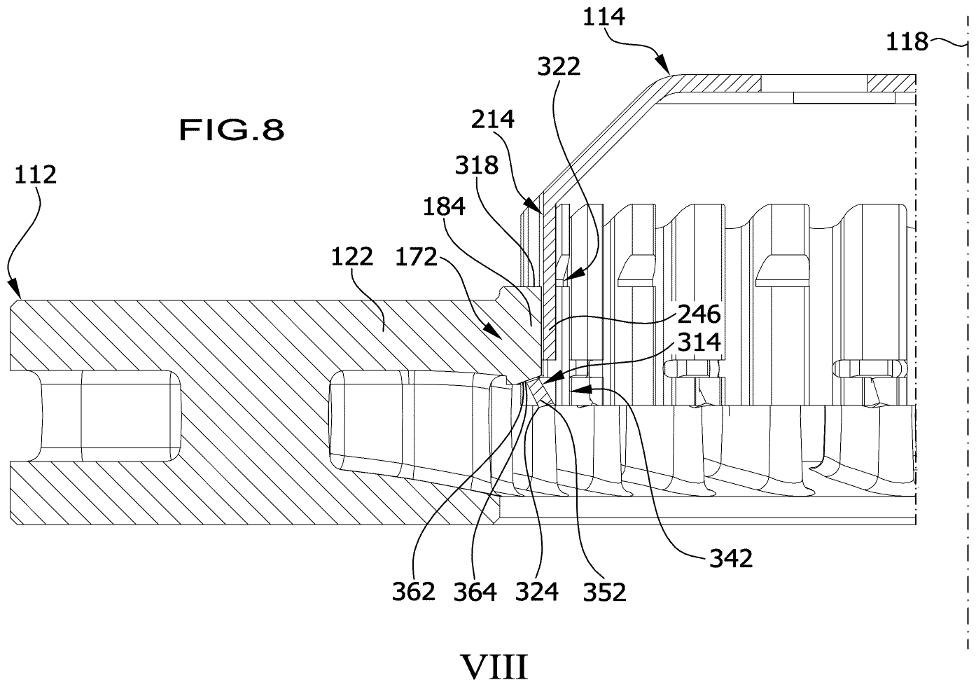

FIG. 9 an enlarged, schematic representation of a detail of a retaining element bearing against a retaining surface running obliquely to the braking system axis; and

FIG. 10 a view of a casing wall of the brake hat similar to FIG. 6, wherein some retaining elements have not yet been shaped from the recess back.

### DETAILED DESCRIPTION OF THE INVENTION

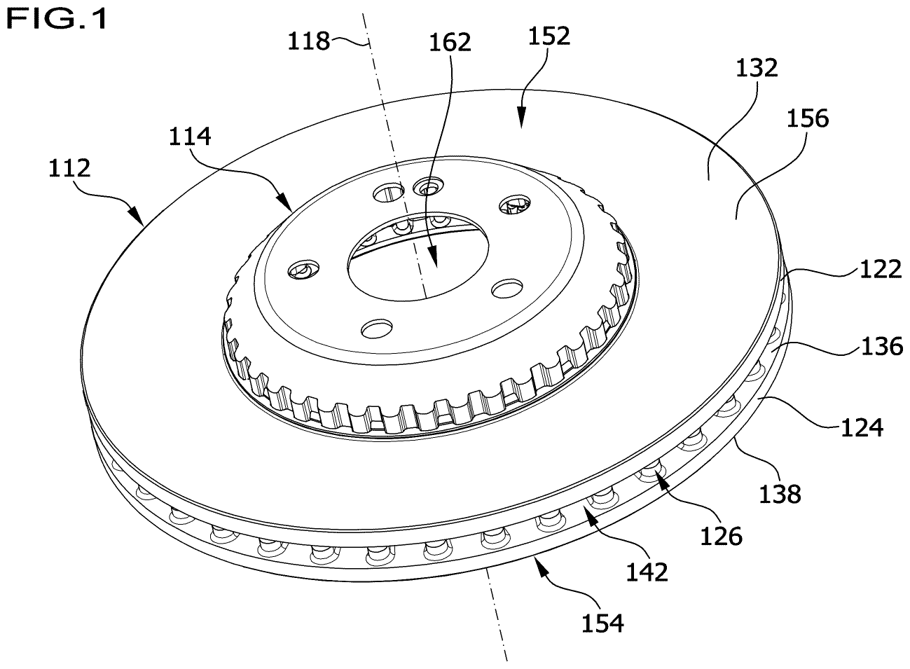

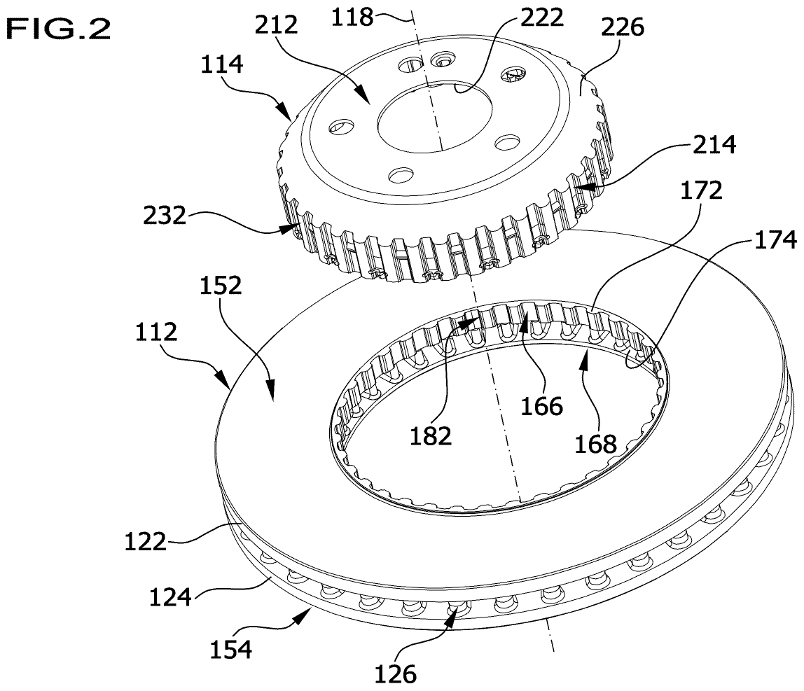

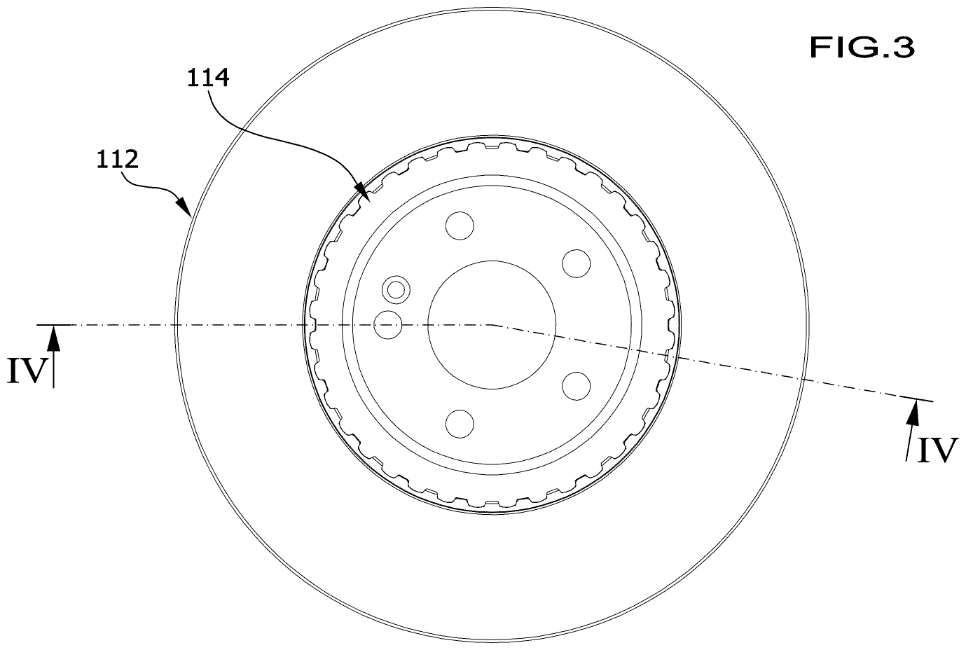

An exemplary embodiment of a braking system denoted by 100 as a whole, which is shown by way of example in the Figures, comprises a friction ring 112 and a brake hat 114, which are arranged coaxially relative to a braking system axis 118, as shown by way of example in FIGS. 1 to 3.

The braking system 100 is intended for a motor vehicle, specifically for arrangement on a vehicle axle thereof. In particular, in the assembled state, the vehicle axle is aligned coaxially relative to the braking system axis 118.

The brake hat 114 is provided for fastening to a vehicle axle of the motor vehicle. The friction ring 112 is configured in particular to interact with brake pads of a brake caliper during a braking process. By means of a torque-transmitting connection between the brake hat 114 and the friction ring 112, the braking effect of the friction ring 112 interacting with the brake pads is transmitted to the brake hat 114 during the braking process, so that the braking effect is also transmitted to the vehicle axle.

The friction ring 112 is formed, for example, from two friction disks 122, 124, which are connected to one another in particular by struts 126 running between the two friction disks 122, 124.

Preferably, the friction disks 122, 124 and the struts 126 are formed in one piece.

For example, the friction disks 122, 124 and the struts 126 are formed from a metal material, for example from cast iron. In variants, the friction disks 122, 124 and, for example, the struts 126 are at least partially made of a ceramic material.

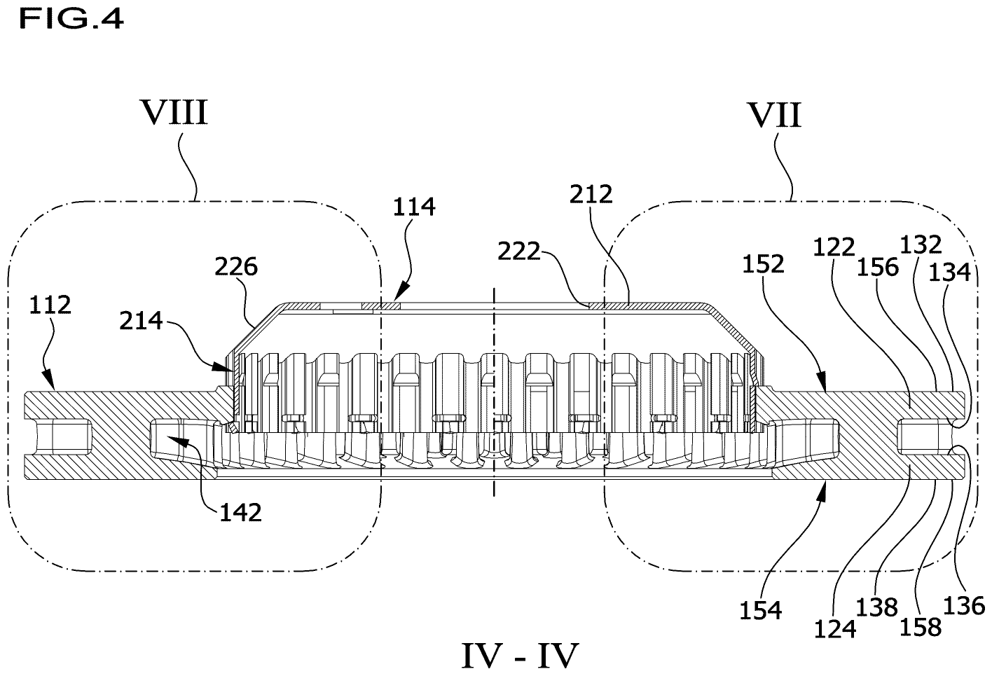

One of the friction disks, in this case the friction disk 122, has two flat sides 132 and 134 and the other of the two friction disks, in this case the friction disk 124, also has two flat sides 136 and 138, as shown by way of example in the sectional view shown in FIG. 4.

The flat sides 132, 134, 136, 138 of the friction disks 122, 124 run at least substantially perpendicular to the braking system axis 118.

The friction disks 122, 124 each face one another with a flat side, in this case with the flat side 134 of the friction disk 122 and with the flat side 136 of the friction disk 124, and, in particular, the struts 126 are arranged on these flat sides 134, 136 facing the other friction disk 122, 124 and thus connect the friction disks 122, 124.

Preferably, the struts 126 run outward obliquely to the radial direction of the braking system axis 118.

Preferably, cooling channels 142 are thus formed in the friction ring 112 between the friction disks 122, 124 by the struts 126.

In each case one flat side of a respective friction disk, here the flat side 132 of the friction disk 122 and the flat side 138 of the friction disk 124, form a respective axial outer side 152, 154 of the friction ring 112.

In particular, the flat side 132, 138 of a friction disk 122, 124 forming an axial outer side 152, 154 is opposite the flat side 134, 136 facing the other friction disk 122, 124 in the direction axial to the braking system axis 118.

On the axial outer sides 152, 154 opposite the braking system axis 118, the friction ring 112 has respective friction surfaces 156, 158, which are formed in particular in a radially outer region of the axial outer sides 152, 154 relative to the braking system axis 118.

The friction surfaces 156, 158 are formed in such a way that brake pads of the braking system 100 can act on these friction surfaces 146, 148 in a frictional and thus braking manner during a braking operation.

In addition, the friction ring 112 has an axle aperture 162 which extends coaxially to the braking system axis 118 continuously from one axial outer side 152 to the other axial outer side 154 of the friction ring 112 through the latter.

In particular, the axle aperture 162 is intended to at least partially receive the brake hat 114 and to allow the vehicle axle to pass through in the fully assembled state.

In this exemplary embodiment, the axle aperture 162 is formed by axle openings 166, 168 formed coaxially relative to the braking system axle 118 in the friction disks 122, 124, wherein the respective axle opening 166, 168 of a friction disk 122, 124 extends from one flat side 132, 136 continuously through the friction disk 122, 124 to the other flat side 134, 138 through this friction disk 122, 124.

The respective axle opening 166, 168 is edged by a respective edge portion 172, 174 in the direction radial to the braking system axis 118, for example the axle opening 166 of the friction disk 122 is edged by the edge portion 172 and the axle opening 168 of the friction disk 124 is edged by the edge portion 174.

The friction surfaces 156, 158 run in a circumferential direction around the braking system axis 118 around the axle aperture 162 and thus also around the respective axle opening 166, 168 of the friction disks 122, 124.

The friction ring 112 comprises a tooth system 182 running circumferentially along the axle aperture 162, said tooth system being configured in particular for a torque-transmitting connection to the brake hat 114.

In this exemplary embodiment, the tooth system 182 is formed on one of the friction discs, for example on the friction disc 122, by the edge portion 172 edging the axle opening 166.

The tooth system 182 has teeth 184 which are arranged circumferentially, in particular periodically, on the axle aperture 162 and here in particular on the axle opening 166 and project radially into the axle aperture 162 and the axle opening 166 relative to the braking system axis 118.

A recess 186 of the tooth system 182 is formed between each two teeth 184 and in particular has a recess back 188, which delimits the open region of the recess 186, which opens out into the axle opening 166 and thus into the axle aperture 162, in the radial direction relative to the braking system axis 118.

In particular, a respective recess back 188 merges in each case into a tooth flank 192 of an adjacent tooth 184, wherein the tooth flanks 192 laterally delimit the recess 186.

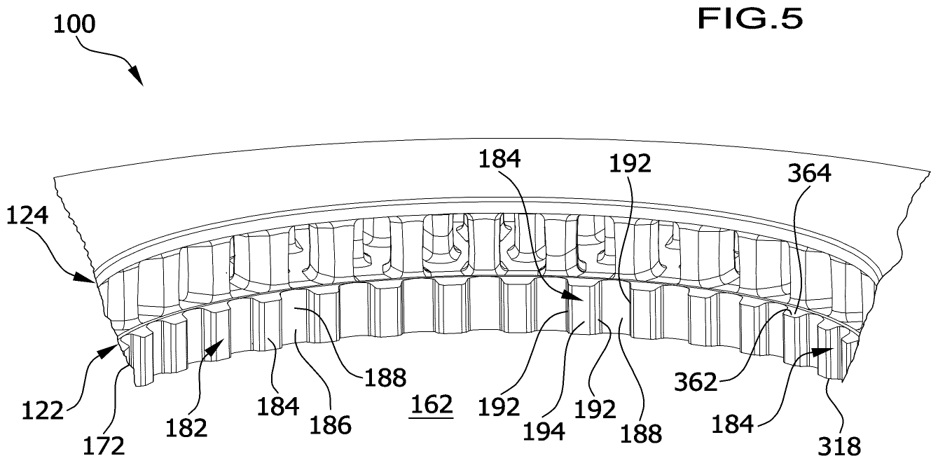

In particular, the teeth 184 with a tooth front 194 thus also project radially into the axle aperture 162 and a respective tooth flank 192 extends from the tooth front 194 radially, for example obliquely to the rear, to a respective recess back 188 arranged on the circumferential side next to the tooth 184, as shown by way of example in FIG. 5.

The teeth 184 and thus also the tooth flanks 192 and tooth fronts 194 extend toward the braking system axis 118 in the axial direction, for example, at least approximately with an extension which corresponds to the thickness of the friction disk 122 measured in the axial direction.

In particular, the brake hat 114 comprises a mounting base 212, which is configured to mount and fasten the brake hat 114 to a vehicle axle, and a casing wall 214, which engages at least partially into the axle aperture 162 of the friction ring 112 in the mounted state to form a connection between the friction ring 112 and the brake hat 114, as shown by way of example in FIGS. 1 and 4.

Preferably, the mounting base 212 and the casing wall 214 and, in particular, the entire brake hat 114 are formed in one piece. Expediently, the brake hat 114 is formed from a metal material and is formed, for example, from a sheet metal.

The mounting base 212 has a mounting opening 222, which is formed coaxially relative to the braking system axle 118 and through which a vehicle axle, to which the brake hat 114 is mounted or is to be mounted, can be passed.

For example, the mounting base 212 is configured as a flat mounting disk.

Preferably, the mounting base 212 has fastening apertures through which fastening means, for example screws, for fastening the brake hat 114 to a vehicle axle, for example to a fastening flange thereof, can be passed through and are passed through in the fully assembled state.

The casing wall 214 runs circumferentially around the braking system axis 118 and preferably extends away from the mounting base 212 in an axial direction relative to the braking system axis 118.

For example, between the mounting base 212 and the casing wall 214, a transition portion 226, which extends at an angle to the axial direction of the braking system axis 118 and is in particular conical in shape, is arranged between the mounting base 212 and the casing wall 214 and connects these two together.

In other variants of the brake hat 114, the casing wall 214 is arranged directly on the mounting base 212.

The brake hat 114 comprises a toothing 232, which is formed so as to correspond to the tooth system 182 of the friction ring 112, wherein the toothing 232 is formed on the casing wall 214.

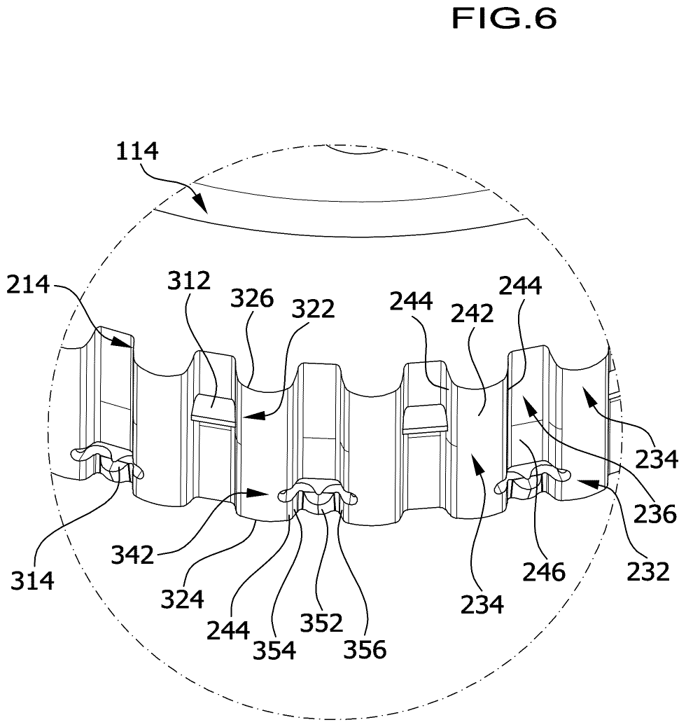

The toothing 232 has teeth 234 projecting radially outward with respect to the braking system axis 118, and a recess 236 is arranged between each two adjacent teeth 234, as shown on an enlarged scale in FIG. 6 by way of example.

The teeth 234 project radially here with a tooth front 242, and tooth flanks 244 extend laterally from the tooth front 242 radially inward, for example obliquely, to a respective recess back 246 of the adjacent recesses 236, wherein the recess back 246 delimits the corresponding recess 236 in a radial direction relative to the braking system axis 118 and respective tooth flanks 244 delimit the recess 236 laterally.

Preferably, the toothing 232 is formed from the casing wall 214, wherein, for example, radially offset wall segments of the casing wall 214 form the tooth fronts 242 and recess backs 246, and wall segments running obliquely thereto form the tooth flanks 244, which in each case connect a wall segment forming a tooth front 242 and a wall segment forming a recess back 246 to one another.

In this case, the teeth 234 of the toothing 232 are formed in such a way that they engage in a respective recess 186 of the tooth system 182 of the friction ring and the teeth 184 of the tooth system 182 are formed in such a way that they engage in a respective recess 236 of the toothing 232.

Preferably, a respective tooth flank 244 of the toothing 232 bears against a corresponding tooth flank 192 of the tooth system 182.

In particular, the meshing of the toothing 232 with the tooth system 182 forms a torque-transmitting connection between the brake hat 114 and the friction ring 112.

For establishing a connection between the brake hat 114 and the friction ring 112, by which the friction ring 112 is held by the brake hat 114, the brake hat 114 comprises a multiplicity of holding elements 312 of a first group and a multiplicity of holding elements 314 of a second group, wherein the retaining elements 312 of the first group and the retaining elements 314 of the second group are arranged offset from one another in the axial direction relative to the braking system axis 118 and hold a part of the friction ring 112 between them and, in particular, prevent an axial relative displacement between the friction ring 112 and the brake hat 114.

In particular, the retaining elements 312, 314 of the first and second group are in contact with the tooth system 182 of the friction disks 122 on axially opposite sides of the edge portion 172.

In particular, the retaining elements 312 of the first group are formed in recesses 236 of the teeth 232 of the brake hat 114.

Preferably, the retaining elements 312 of the first group are each formed as an axial stop, in particular as a stop projecting from the recess back 246 into the open space of the recess 236.

In particular, the retaining elements 312 of the first group are arranged on the casing wall 214 in such a way that they bear against an axial end of the edge portion 172, here in particular against an axial end 318 of a tooth 184, wherein the axial end 318 is formed, for example, on an axial outer side, here on the axial outer side 152, of the friction ring 112.

For example, the retaining elements 312 of the first group are arranged in an axial middle region 322 of the casing wall 214, wherein the axial middle region 322 lies between a free axial end 324 of the casing wall 214 and an opposite axial end 326 of the casing wall 214, at which the casing wall 214 is connected to the mounting base 212, for example by means of the transition portion 226.

In particular, the axial end 318 of the edge portion 172, in particular of the teeth 184 in each case, has a substantially flat retaining surface 332 against which the corresponding retaining element 312 bears, wherein preferably the retaining surface 332 extends at least approximately perpendicularly to the axial direction of the braking system axis 118.

The retaining elements 314 of the second group are arranged in a region axially offset from the region in which the retaining elements 312 of the first group are arranged, in this case from the axial middle region 322, relative to the braking system axis 118, in this case in an end region 342 at the free axial end 324 of the casing wall 214.

In this case, the two regions in which, on the one hand, the retaining elements 312 of the first group and, on the other hand, the retaining elements 314 of the second group are arranged are at least substantially axially spaced apart from one another in such a way that their spacing substantially corresponds to an axial thickness of the friction disk 122.

Preferably, the retaining elements 314 of the second group are arranged in recesses 236 of the toothing 232 and are shaped from the recess back 246.

In particular, a part of the recess back 246 is pressed radially outward into the open space of the recess 236 as retaining part 352 of the retaining element 314 and, with respect to the circumferential direction on both sides of the retaining part 352, fastening parts 354, 356 are formed from the casing wall 214, which connect and then fasten the retaining part 352 on both sides in each case to a tooth flank 244, which delimit the corresponding recess 236 in which the retaining element 314 is formed.

In particular, the retaining part 352 extends obliquely to the axial direction of the braking system axis 118.

The retaining elements 314 of the second group bear against retaining surfaces 362 of the edge portion 172 of the friction disk 122, wherein the retaining surfaces 362 for the retaining elements 314 of the second group are formed on an axially opposite side of the edge portion 172 to the retaining surfaces 332 for the retaining elements 312 of the first group.

Since the retaining elements 314 are formed in recesses 236 of the toothing 232 of the casing wall 214, the retaining surfaces 362 are preferably formed at an axial end 364 of a corresponding tooth 184 engaging in the recess 236, wherein this axial end 364 is oriented in the opposite axial direction to an axial end 318 of a tooth 184 against which a retaining element 312 of the first group bears.

In this case, the retaining surfaces 362 for retaining elements 314 of the second group advantageously run obliquely to the axial and radial direction relative to the braking system axis 118.

For example, the retaining surfaces 362 running at an angle to the axial and radial directions are formed by a chamfer on the edge portion 172, which in particular runs circumferentially around the axle opening 166.

In particular, the retaining surface 362 runs obliquely and is formed at the edge portion 172 in such a way that a free region adjoining the retaining surface 362 transitions freely into the open region of the axle aperture 162 in a radial direction relative to the braking system axis 118, at least as long as the brake hat 114 is not yet at least partially inserted into the axle aperture 162.

Preferably, a respective part of the casing wall 214, in particular a respective recess back 246, is arranged directly adjacent to the free region of a respective retaining surface 362 and the retaining element 314 placed against the retaining surface 362 is shaped from this part.

The retaining elements 314 of the second group preferably bear against the retaining surface 362 with preload and/or are wedged therewith, and thus the retaining elements 312 of the first group together with the retaining elements 314 of the second group form a connection which is under preload and/or is self-locking, by means of which the friction ring 112 is retained on the brake hat 114.

Preferably, the holding elements 314 of the second group, in particular their respective holding part 352, rest at least approximately vertically on the obliquely running holding surface 362 with their extent running away from the holding surface 362.

In this case, the extent of the holding part 352 running away from the holding surface 362 runs at least substantially perpendicular to a transverse direction in which the two fastening parts 354, 356 are fastened to the holding part 352.

In particular, a structure, a mode of operation and advantages of the braking system 100 are thus briefly summarized as follows.

The brake hat 114 can be mounted on a vehicle axle, in particular by means of the mounting base 212, and the friction ring 112 with its friction surfaces 156 and 158 can interact with brake pads of brake shoes, for example, in a braking manner, wherein the braking effect is transmitted to the vehicle axle by means of the brake hat 114 by way of the torque-transmitting connection between the friction ring 112 and the brake hat 114, in particular by means of the meshing tooth system 182 and toothing 232.

For axial securing of the friction ring 112 relative to the brake hat 114, the friction ring 112, in particular the edge portion 172 of the friction disk 122, is held between the holding elements 312 of the first group and the holding elements 314 of the second group, which engage on axially opposite sides of the friction ring 112, in particular of the edge portion 172, and hold the friction ring in place.

Due to the fact that the retaining surfaces 362 for the retaining elements 314 of the second group run obliquely to the axial direction of the braking system axis 118, these retaining elements 314 can be placed in a self-locking manner against the corresponding obliquely running retaining surface 362 and wedged therewith, for example.

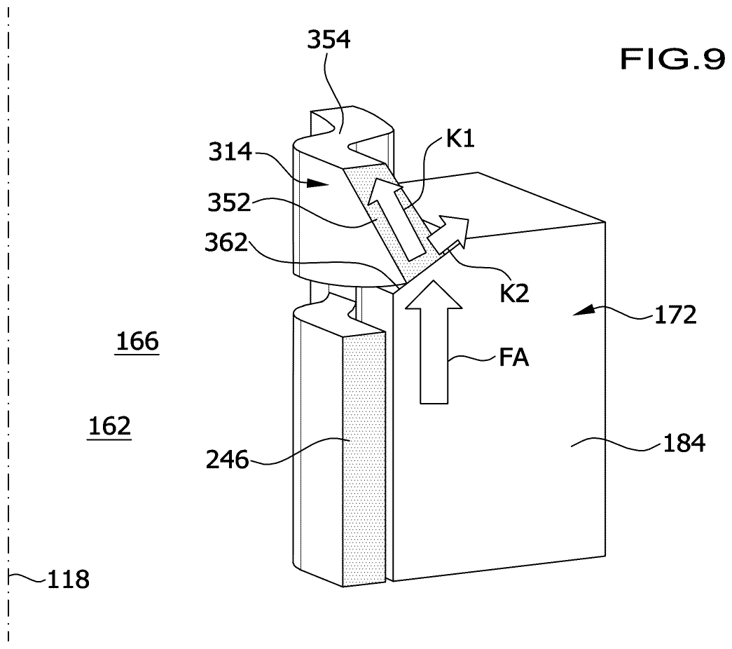

When the friction ring 112 is axially loaded during operation, an axial force FA is exerted by the friction ring 112, in particular the tooth 184, onto the retaining element 314, in particular its retaining part 352, which stands at least approximately perpendicularly on the retaining surface 362, wherein a component K1 of the axial force FA is absorbed by the retaining element 314, in particular the retaining part 352, along the extent of said retaining element running away from the retaining surface 362, and a component K2 of the force FA running at least approximately perpendicularly thereto displaces the retaining element 314, in particular the retaining part 352, along the oblique retaining surface 362, specifically along a part of the holding surface 362 that protrudes further in the axial direction, so that the holding element 314 preferably remains in contact with the holding surface 362 without play and in particular remains wedged against the latter, as shown by way of example in FIG. 9.

Advantageously, when an axial load is applied between the friction ring 112 and the brake hat 114, the connection between the two is thus not loosened, but remains free of play and their fastening parts wedge together so that a stable connection is maintained.

In particular, the braking system 100, and in particular the connection between the friction ring 112 and the brake hat 114, is structurally easy to manufacture.

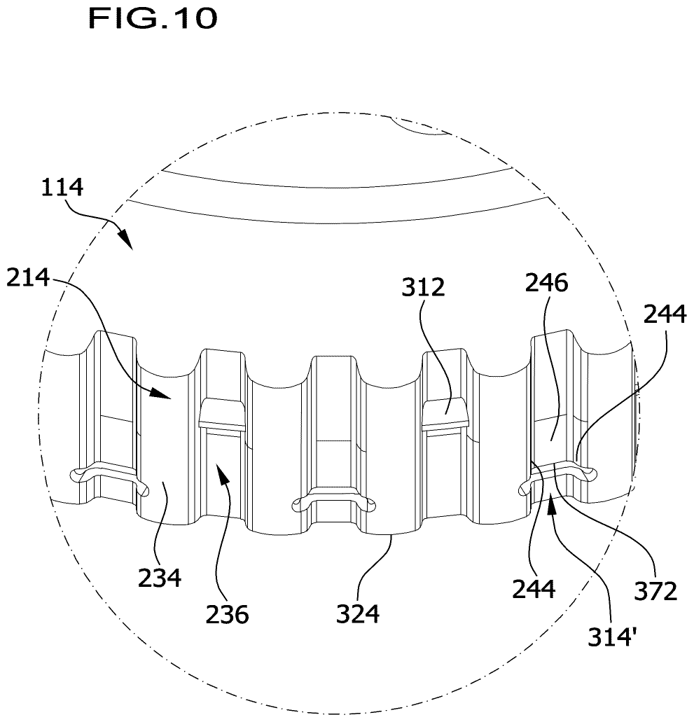

In particular, the brake hat 114 is inserted into the axle aperture 162 with the free axial end 324 of the casing wall 214 at the fore, with retaining elements 314 not yet shaped, wherein a part 314′ of the recess back 246, which is shaped into the retaining element 314 in a subsequent step, is thus still in the position of the recess back 246, as shown by way of example in FIG. 10.

The retaining elements 312 of the first group in the axial middle region 322 are in particular already shaped here and thus form a stop for the proper axial alignment of the brake hat 114 relative to the friction ring 112 in relation to the braking system axis 118 during the insertion process.

In variants in which the retaining elements 312 of the first group forming the stops are formed at the free axial end 324, the brake hat 114 is inserted with its axially opposite end, at which in particular the mounting base 212 is arranged, at the fore into the axle aperture until the retaining elements 312 come into contact with their corresponding retaining surfaces 332.

If the brake hat 114 is then correctly positioned relative to the friction ring 112, the retaining element 314 can be shaped from the part 314′ in an assembly step by radial shaping and simultaneously placed against the retaining surface 362 with the shaping.

For example, the radial shaping and bearing placement of the retaining elements 314 of the second group is carried out with a slide tool acting in the radial direction and preferably force-controlled.

The simple radial shaping of the retaining elements 314 is made possible in particular by the fact that the free region present in front of the retaining surface 362 transitions freely into the axle aperture 162, so that the part 314′, which is arranged directly adjacent to the free region, can be placed against the retaining surface 362 through the free region.

Preferably, the part 314′ of the recess back 246 to be shaped into the retaining element 314 is separated by a slot 372, which in particular extends circumferentially along the entire recess back 246 and preferably into the adjacent tooth flanks 244.

In the variants shown in the Figures, the part 314′ for the retaining element 314 is formed at the free axial end 324, so that a slot 372 is formed only at the end of the part 314′ opposite the axial end 324.

In other variants, in which the part 314′, from which the retaining element 314 is formed, is formed remote from the axial end 324, a slot 172 is preferably formed on both sides of the part 314′ in the axial direction.

For example, in some variants it is provided that the retaining elements 312 of the first group are formed at the axial end 324 and the retaining elements 314 of the second group are shaped in the axial middle region 322.

In some expedient variants, it is provided that not only the retaining surfaces 362 for the retaining elements 314 of the second group, but also the retaining surfaces 332 for the retaining elements 312 of the first group are formed in a corresponding manner obliquely to the axial direction of the braking system axis 118.

For example, a retaining element 312, 314 of the first or second group is arranged in each of the recesses 236 of the toothing 232 of the brake hat 114.

Preferably, it is provided here that a retaining element 312 of the first group is arranged alternately in the recesses 236 and a retaining element 314 of the second group is arranged in the subsequent recess 236.

In variants of the exemplary embodiment, for example, it is provided that both a retaining element 312 of the first group and a retaining element 314 of the second group are formed in at least some recesses 236.

In some variants of the exemplary embodiment it is provided that, in some recesses 236, no retaining element 312, 314 is formed.

### LIST OF REFERENCE NUMERALS

100 braking system
112 friction ring
114 brake hat
118 braking system axis
122 friction disk
124 friction disk
126 struts
132 flat side
134 flat side
136 flat side
138 flat side
142 cooling channels
152 axial outer side
154 axial outer side
156 friction surface
158 friction surface
162 axle aperture
166 axle opening
168 axle opening
172 edge portion
174 edge portion
182 tooth system of the friction ring
184 teeth
186 recess
188 recess back
192 tooth flank
194 tooth front
212 mounting base
214 casing wall
222 mounting opening
226 transition portion
232 toothing of the brake hat
234 teeth
236 recess
242 tooth front
244 tooth flanks
246 recess back
312 retaining elements of the first group
314 retaining elements of the second group
318 axial end of a tooth
322 axial middle region
324 free axial end
326 axial end
332 retaining surface for retaining elements of the first group
342 end region
352 retaining part
354 fastening part
356 fastening part
362 retaining surface for retaining elements of the second group
364 axial end
372 slot

What is claimed:

1. A braking system for a motor vehicle, comprising a friction ring and a brake hat which is configured for fastening the friction ring to a motor vehicle axle, wherein the friction ring and the brake hat are connected to one another by at least one of a self-locking connection and/or a self-braced connection.

2. The braking system in accordance with claim 1, wherein the connection between the friction ring and the brake hat is configured as a connection between the friction ring and the brake hat which braces at least in the event of an axial load on the connection relative to a braking system axis.

3. The braking system in accordance with claim 1, wherein the connection between the friction ring and the brake hat braces increasingly as a load increases, at least when the load is axial relative to the braking system axis.

4. The braking system in accordance with claim 1, wherein the connection between the friction ring and the brake hat is under preload.

5. The braking system in accordance with claim 1, wherein parts of the friction ring and parts of the brake hat, which at least partially form the connection between the friction ring and the brake hat, are wedged together.

6. The braking system in accordance with claim 1, wherein the connection between the friction ring and the brake hat is formed at least partially from a plurality of retaining surfaces and a plurality of retaining elements, the retaining elements bear against a respective retaining surface.

7. The braking system in accordance with claim 6, wherein at least some of the plurality of retaining surfaces extend obliquely to a braking system axis.

8. The braking system in accordance with claim 6, wherein at least some of the plurality of retaining elements bear against the respective retaining surface under preload.

9. The braking system in accordance with claim 6, wherein at least some of the plurality of retaining elements are formed by the brake hat and at least some of the plurality of retaining surfaces are formed on the friction ring.

10. The braking system in accordance with claim 1, wherein a casing wall of the brake hat has a toothing and the friction ring has a tooth system corresponding to the toothing, wherein the toothing and the tooth system are toothed together.

11. The braking system in accordance with claim 6, wherein at least some of the plurality of retaining elements are formed from a casing wall of the brake hat.

12. The braking system in accordance with claim 6, wherein at least some of the plurality of retaining elements are each formed in a respective recess between two teeth of a tooth system of the brake hat.

13. The braking system in accordance with claim 6, wherein at least some of the plurality of retaining elements each comprise a retaining part resting against the respective retaining surface, and wherein the retaining part is fastened to a casing wall of the brake hat by means of two fastening parts of the retaining element.

14. The braking system in accordance with claim 6, wherein at least some of the plurality of retaining elements are fastened by their fastening parts to a respective tooth flank of a tooth system of the casing wall.

15. The braking system in accordance with claim 6, wherein at least some of the plurality of retaining elements bear obliquely to a braking system axis on the corresponding retaining surface.

16. The braking system in accordance with claim 6, wherein the brake hat comprises two groups of retaining elements, wherein the retaining elements of one of the two groups are arranged at one axial height of a casing wall of the brake hat and the retaining elements of the other of the two groups are arranged at a different axial height of the casing wall of the brake hat, and the retaining elements of the two groups hold the friction ring between them in the axial direction relative to a braking system axis.

17. The braking system in accordance with claim 16, wherein the retaining elements of one of the two groups are formed at a free axial end of the casing wall.

18. The braking system in accordance with claim 6, wherein at least some of the plurality of retaining elements are formed by radial shaping from a casing wall of the brake hat.

19. The braking system in accordance with claim 6, wherein at least some of the plurality of retaining elements are placed directly against a corresponding retaining surface by a radial shaping.

20. The braking system in accordance with claim 6, wherein at least some of the plurality of retaining surfaces are formed on a tooth system of the friction ring.

21. The braking system in accordance with claim 6, wherein at least some of the plurality of retaining surfaces are formed on an axial end of a respective tooth of a tooth system of the friction ring relative to a braking system axis.

22. The braking system in accordance with claim 6, wherein at least some of the plurality of retaining surfaces are formed on the friction ring in such a way that a free region on a respective retaining surface opens freely into an axle aperture of the friction ring in a radial direction relative to a braking system axis.

23. The braking system in accordance with claim 1, wherein a respective part of a casing wall of the brake hat is arranged directly adjacent to a free region of at least some of a plurality of retaining surfaces.
